(19) United States
(12) Patent Application Publication
(10) Pub. No.: US 2009/0241329 A1
(43) Pub. Date: Oct. 1, 2009

(54) SIDE RAIL REMOVER

(75) Inventor: Anucha KITTIUDCHAWAN, Samutprakarn (TH)

Correspondence Address: SUGHRUE MION, PLLC, 2100 PENNSYLVANIA AVENUE, N.W., SUITE 800, WASHINGTON, DC, 20037, US

(73) Assignee: UTAC Thai Limited, Bangkok (TH)

(21) Appl. No.: 12/410,034

(22) Filed: Mar. 24, 2009

Related U.S. Application Data
(60) Provisional application No. 61/040,404, filed on Mar. 28, 2008.

(51) Int. Cl. B23P 19/00

(52) U.S. Cl. 29/762

(57) ABSTRACT

Side rail removal apparatus and method for removal of side rails are provided. The side rail removal apparatus includes a side rail removal assembly, side rail removal pins, a turn-table, and upper and lower holders for the removal pins. Hence, the user can remove the side rails of UV tape without causing scratching to an IC package.

This application claims priority from U.S. Provisional Application No. 61/040,404 filed on Mar. 28, 2008, the disclosure of which is incorporated herein by reference.

### BACKGROUND OF THE INVENTION

1. Field of the Invention

Apparatuses and methods consistent with the present invention relate to removal of side rails of a lead frame from an adhesive, and more particularly, to removal of side rails of the lead frame from an adhesive which secures and holds semiconductor packages to the lead frame.

2. Description of the Related Art

A plurality of semiconductor packages are manufactured at the same time on a lead frame. These packages are subsequently separated during a singulation process using a singulation blade.

The high speed circular singulation blade cuts a work piece, usually a semiconductor package, into molded panels, upon a lead frame, secured to the lead frame by an adhesive. However, this leaves significant portions of a the lead frame around the molded panels attached to the adhesive. Conventionally, to remove the side rails of the lead frame, a technician uses a manual device. Conventionally, to remove the side rails of the lead frame, a technician uses a manual device.

However, the conventional method of removing side rails manually makes it difficult to control consistency removing the position of the side rail. The IC package can be easily scratched before removal from the singulation tape. Thus, an apparatus and method are required in order to prevent scratching and increase the efficiency, precision and ease in removal of side rails.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a rail removal apparatus and method thereof to remove rails from a Lead frame which has been singulated.

According to an aspect of the present invention, there is provided a rail removal apparatus, comprising a rail removal assembly, a first frame which can be re-oriented, and a panel on which the frame is secured and to which the rail removal assembly can be attached and where, the rail removal assembly can be moved over the frame and panel.

The rail removal apparatus may further comprise an upper holder for controlling a first set of at least one pin, and a lower holder for controlling a second set of at least one pin.

The first set of at least one pin may contain two pins and the second set of at least one pin may contain six pins.

When the upper holder is pushed downwards, the first set of at least one pin may be pushed downwards towards the first frame. Similarly, when the lower holder is pushed downwards, the second set of at least one pin may be pushed downwards towards the first frame.

The rail removal apparatus may further comprise a second frame secured to the first frame. The first frame may be a ring frame and the second frame may be a lead frame holding a work piece.

The panel of the rail removal apparatus may further comprise of at least one channel through which the rail removal assembly can move over the panel.

The first frame of the rail removal apparatus may further comprise of at least one blocking nut.

According to another aspect of the present invention, there is provided a rail removal method, comprising placing a first frame on a side rail removal apparatus with removal pins, pushing a rail removal assembly over the first frame, where the pins may remove rails from the second frame until all of the rails of the second frame are removed in a horizontal orientation, returning the rail removal assembly to a home position and then rotating the first frame to a different position, pushing the rail removal assembly over the first frame, where the pins may remove rails from the second frame until the rails of the second frame are removed in a vertical orientation.

The rail removal method may further comprise that when the rails of the second frame are removed in a horizontal direction, a blocking nut prevents the pins from removal of the rails of the second frame in a vertical position.

The rail removal method may further comprise that when the rails of the second frame are removed in a vertical direction, a blocking nut prevents the pins from removal of the rails of the second frame in a horizontal position.

### BRIEF DESCRIPTION OF THE DRAWING FIGURES

The above and/or other aspects of the present invention will be more apparent by describing certain exemplary embodiments of the present invention with reference to the accompanying drawings, in which:

FIG. 1 is a diagram of a side rail removal apparatus according to an exemplary embodiment of the present invention;

FIG. 2 is a detailed diagram of a side rail removal apparatus according to an exemplary embodiment of the present invention;

FIG. 3 is a diagram of a side rail removing assembly;

FIGS. 4A and 4B are diagrams of a side rail removal apparatus with and without a ring frame with a lead frame mounted on the ring frame; and

FIGS. 5-16 are diagrams illustrating the method of removing the side rails from an adhesive; and

FIG. 17 is a diagram of the side rail removing assembly detailing the blocking nut for protecting against use of the wrong set of removal pins.

### DETAILED DESCRIPTION OF THE EXEMPLARY EMBODIMENTS

Certain exemplary embodiments of the present invention will now be described in greater detail with reference to the accompanying drawings.

In the following description, all elements retain their drawing reference numerals throughout the drawings. The matters defined in the description, such as detailed construction and elements, are provided to assist in a comprehensive understanding of the invention. Thus, it is apparent that the exemplary embodiments of the present invention can be carried out without those specifically defined matters. Also, well-known functions or constructions are not described in detail since they would obscure the invention with unnecessary detail.

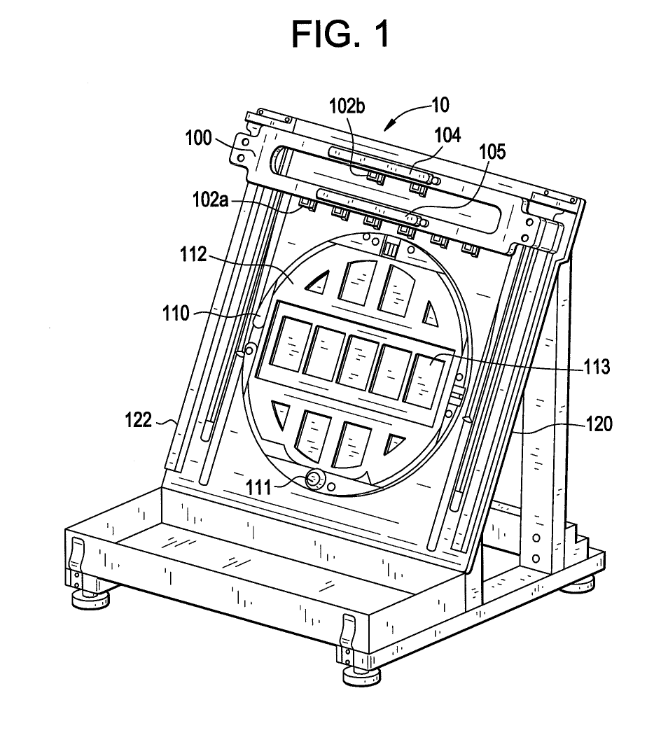

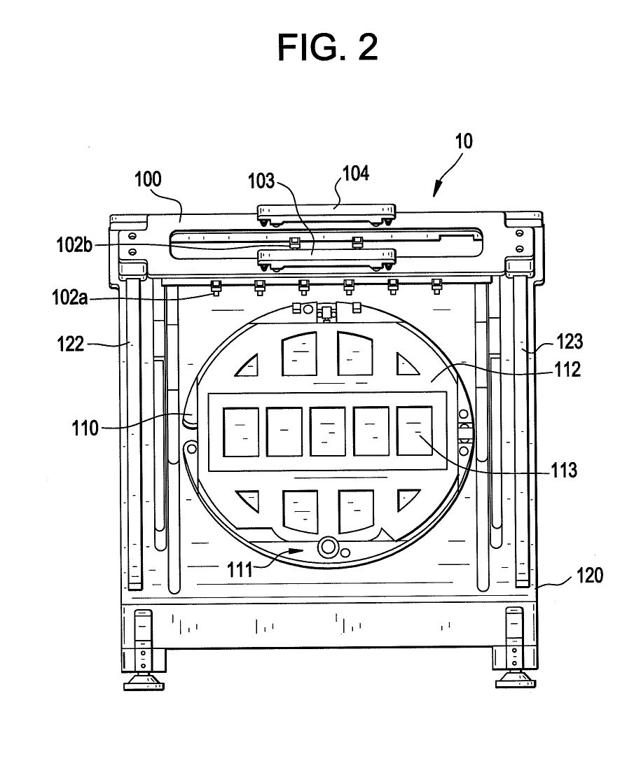

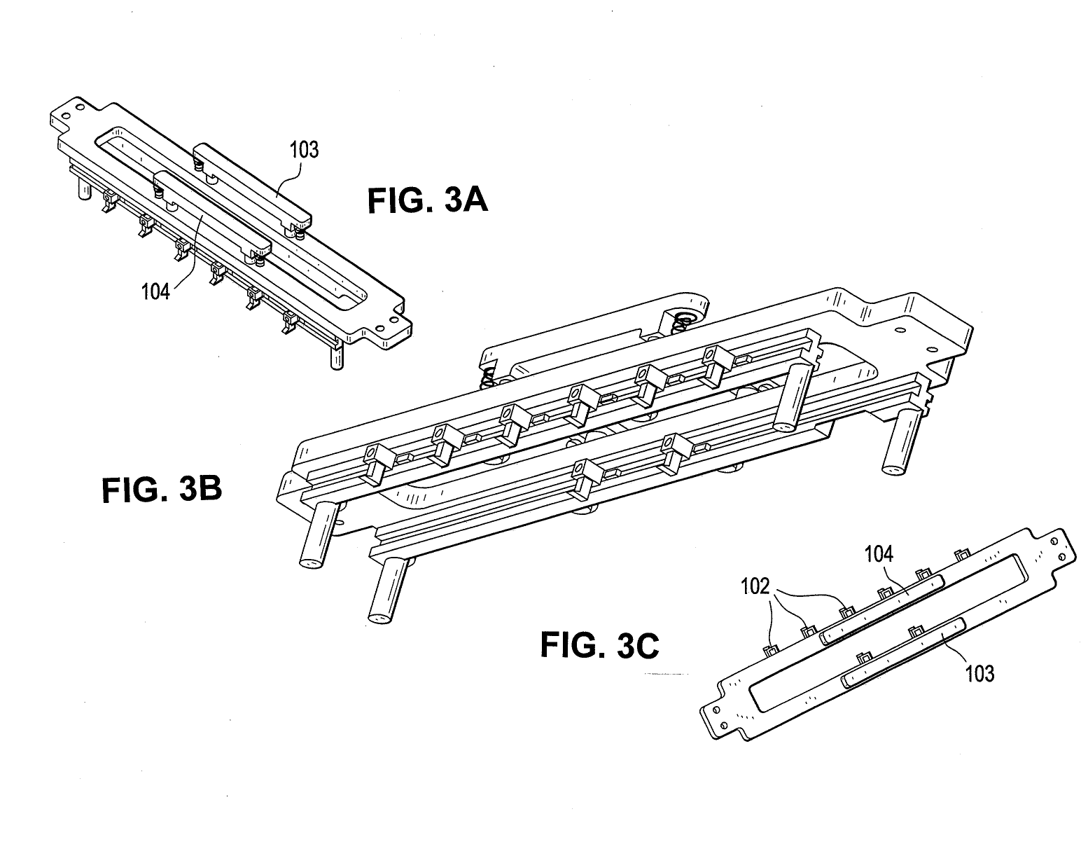

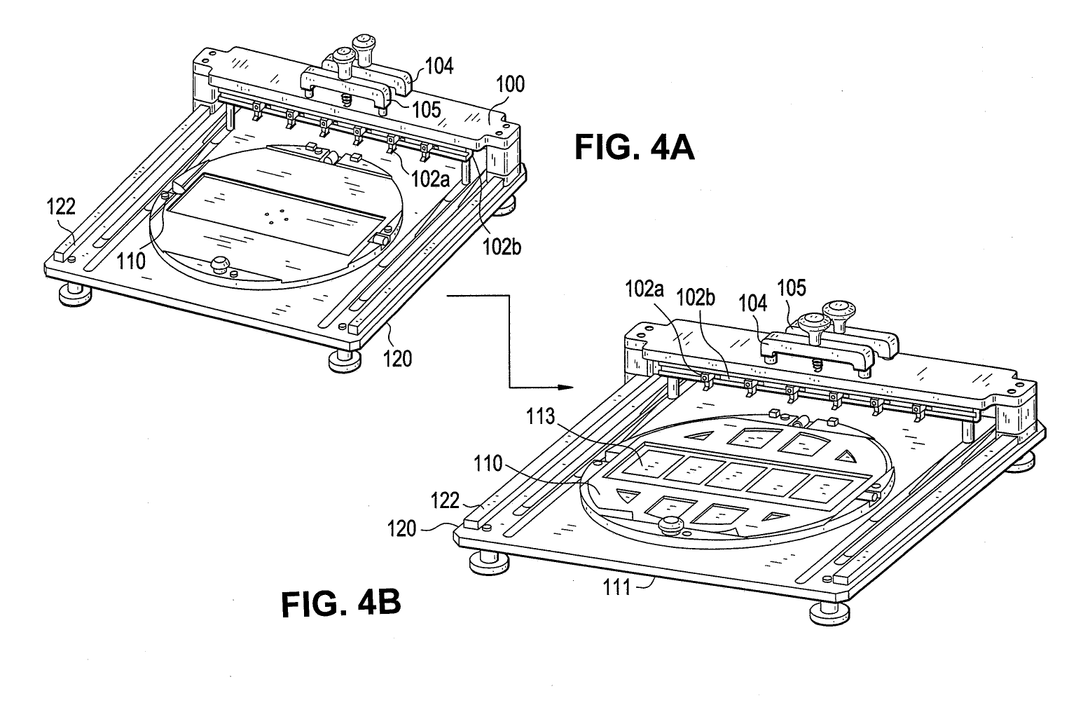

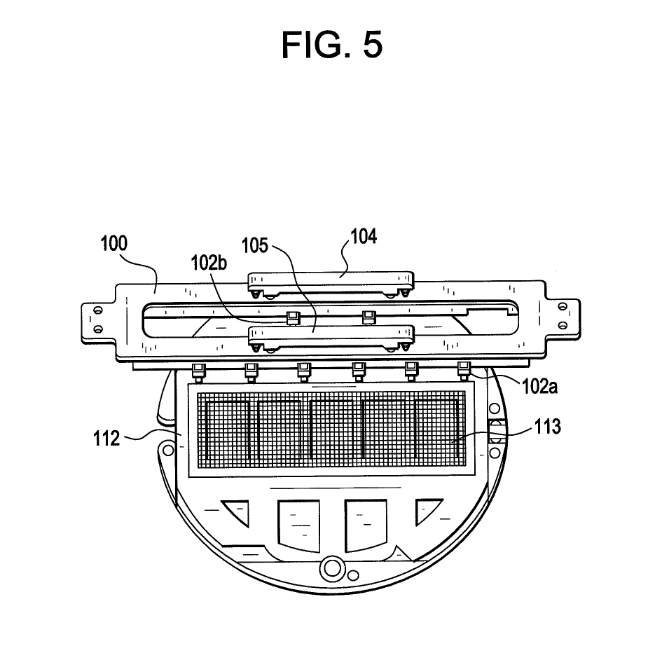

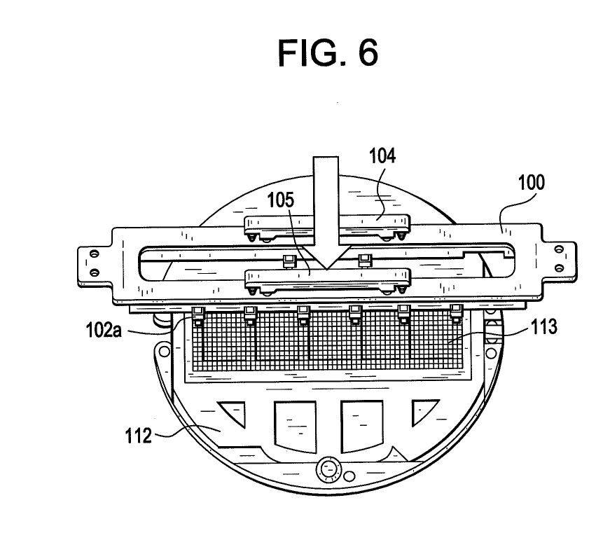

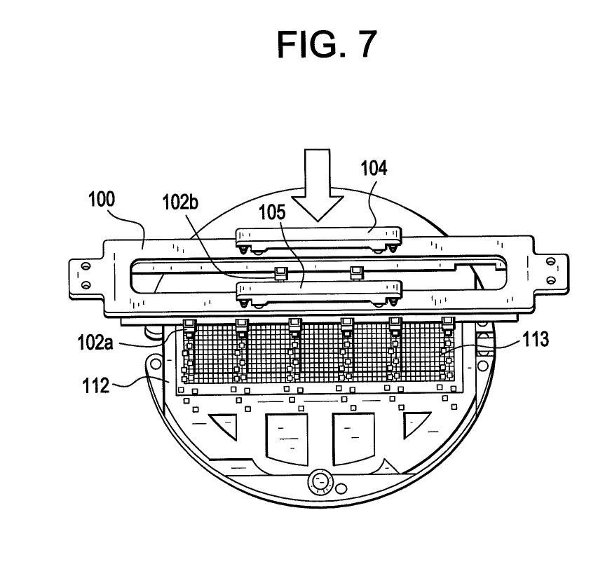

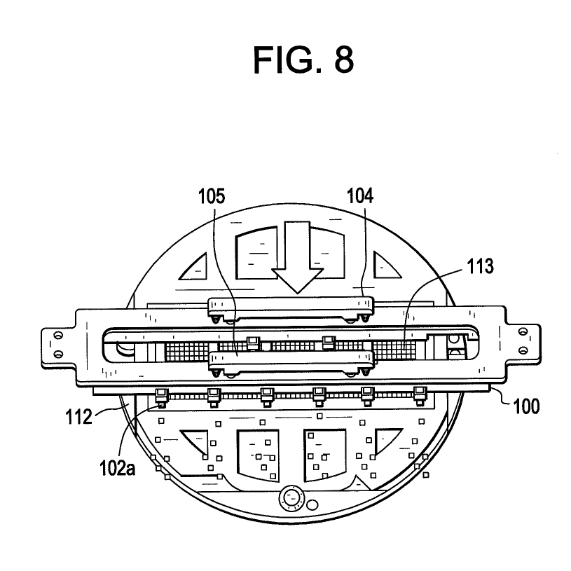

FIGS. 1 and 2 are diagram of a side rail removal apparatus 10 according to an exemplary embodiment of the present invention. In this embodiment, the side rail removal apparatus 10 has a ring frame 112 with a lead frame 113 mounted on it, providing the ability to easily and quickly remove the side rails from the lead frame 113, preventing scratching and greater control over consistency of the removal.

The side rail removal apparatus includes a side rail removing assembly 100, a turn table 110, and a mounting platform 120.

The side rail removing assembly 100 is mounted on a side rail removal platform 120 and slides over a ring frame 112 with a lead frame 113 mounted on it by an adhesive, such as an UV tape (however, other adhesives could also be used), through channels 122 and 123. The side rail removing assembly 100 comprises at least one side rail removing pin 102a/102b, a lower holder 103, and an upper holder 104.

The lower holder 103 holds six side rail removing pins 102a which will remove the side rails from the lead frame.

The ring frame 112 is placed on the side rail removal platform 120. The side rail removing assembly 100 is in the home position, where it rests before any action has taken place. The lower holder 103 is then pushed down and held in the down position and the side rail removing assembly 100 is slid towards the horizontal lead frame 113.

When the lower holder is pushed down, the first set of side rail removing pins 102a become engaged and each side rail removing pin will come in contact with side rails of the lead frame, in a horizontal orientation. Blocking nuts 124 and 125 prevent the second set of side rail removing pins 102b from becoming engaged and touching or damaging the IC package.

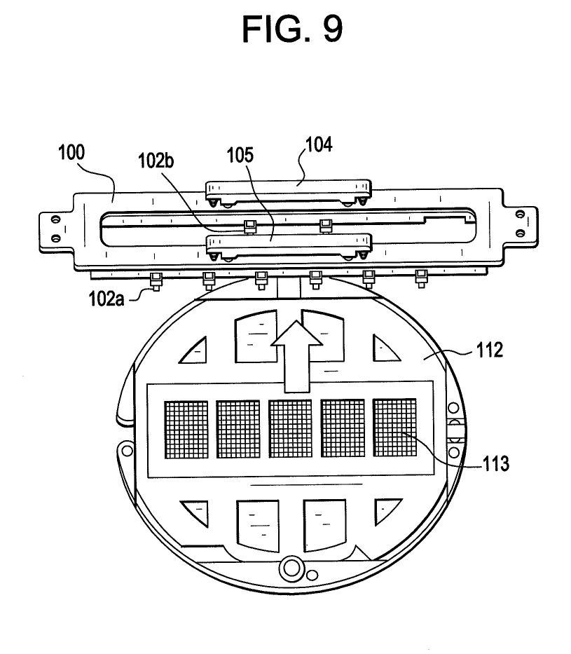

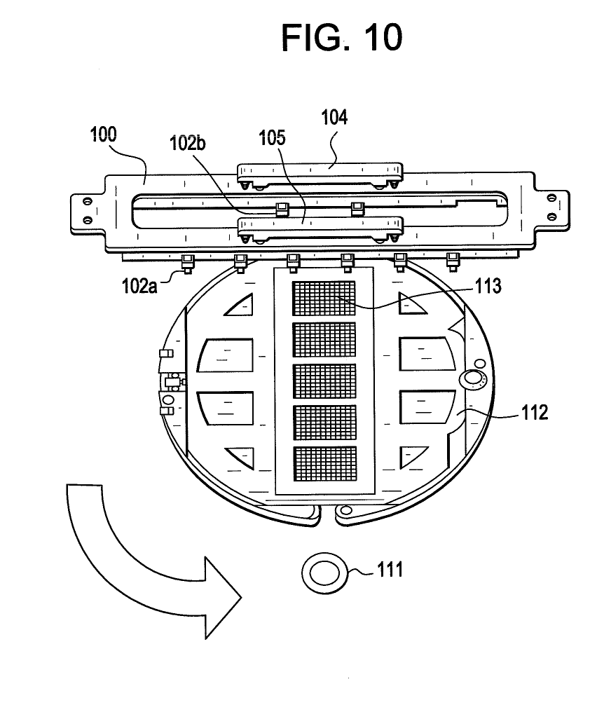

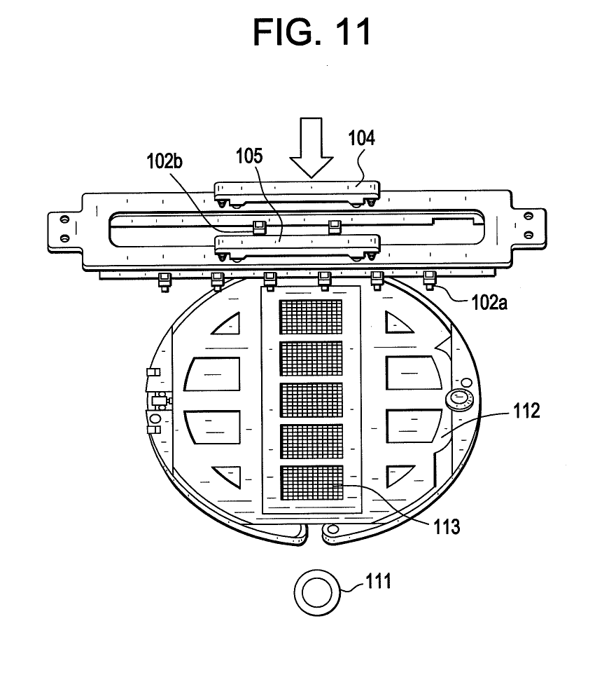

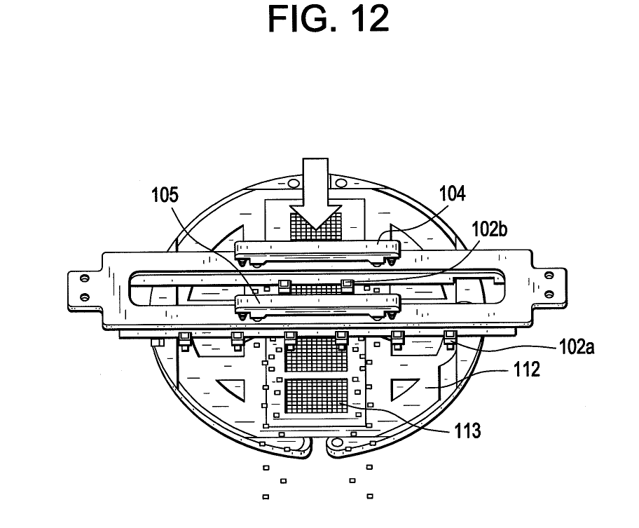

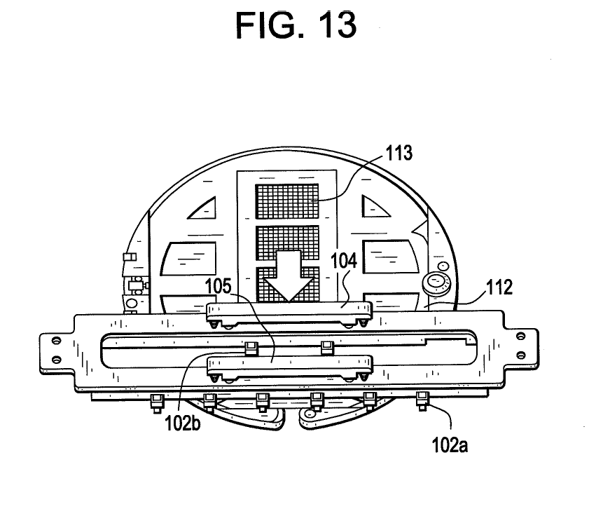

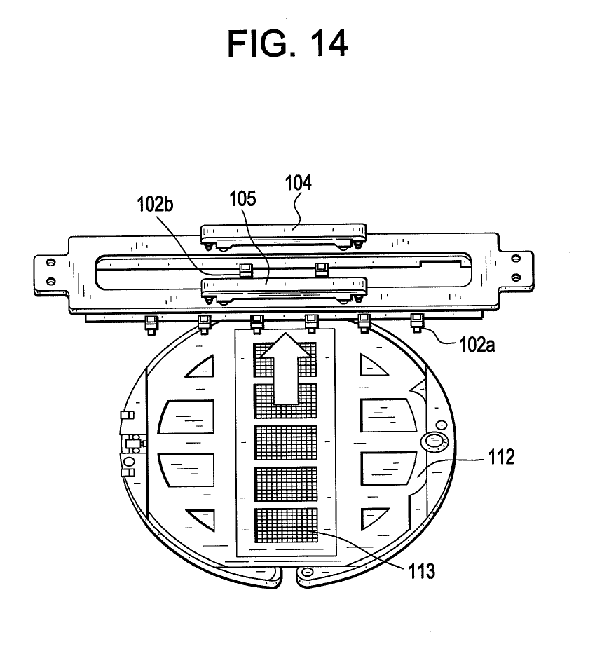

Each of the six pins 102a will remove the side rails on the side to the left and the right of a previously singulated semiconductor package. Once the side rail removal assembly 100 has reached the end of its stroke, the side rail removal assembly can be slid back to the home position as shown in FIG. 9.

The user then turns the turn table 110 using the knob 111 ninety (90) degrees such that the lead frame 113 is in a vertical position relative to the side rail removal assembly 100.

The side rail removing assembly 100 is again in the home position, where it rests before any action takes place. The upper holder 104 is then pushed down and held in the down position and the side rail removing assembly 100 is slid towards the vertically oriented lead frame 113.

When the upper holder is pushed down, the second set of side rail removing pins 102b become engaged and each side rail removing pin 102b will come in contact with side rails of the lead frame attached to an adhesive, in a vertical orientation. Blocking nuts 126, 127, 128 and 129 prevent the second set of side rail removing pins 102b from becoming engaged and touching the IC package.

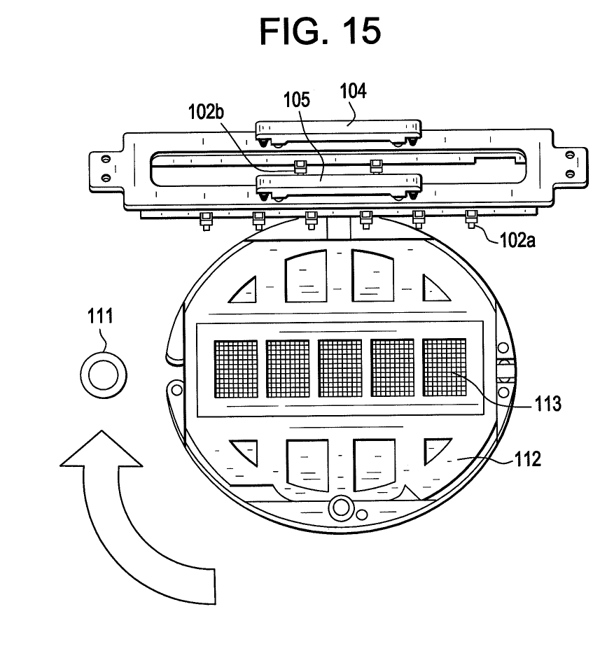

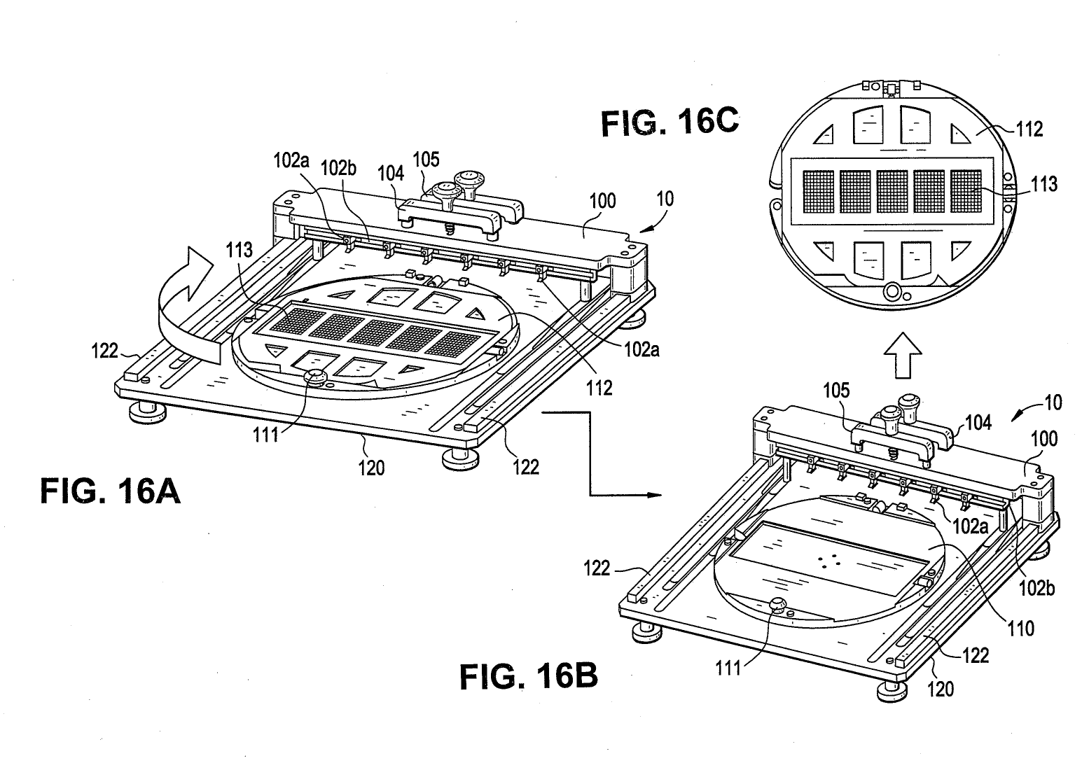

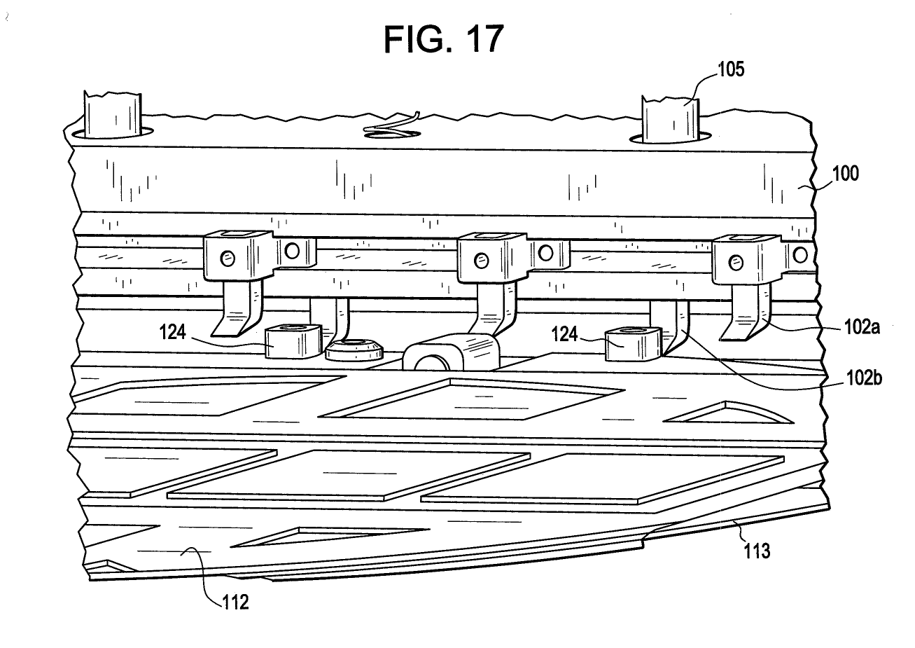

Each of the six pins will remove the side rails on the side to the left and the right of a previously singulated semiconductor package, in a vertical orientation. Once the side rail removal assembly 100 has reached the end of its stroke, the side rail removal assembly can be slid back to the home position as in FIG. 15.

The user then turns the turn table 110 using the knob 111 ninety (90) degrees such that the lead frame 113 is in a horizontal position relative to the side rail removal assembly 100, and the ring frame can be removed from the rail removal apparatus.

A rail removal apparatus comprising a ring frame, Lead frame, sliders and a side rail removing assembly with 8 pins is illustrated to remove side rails of UV tape of an IC package, by way of example. The present invention is applicable to other shaped frames and other work pieces.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A rail removal apparatus comprising:
a rail removal assembly,
a first frame which can be re-oriented, and
a panel on which the frame is secured and to which the rail removal assembly can be attached;
wherein, the rail removal assembly can be moved over the frame and panel.

2. The rail removal apparatus of claim 1, wherein rail removal assembly further comprises:
an upper holder for controlling a first set of at least one pin, and
a lower holder for controlling a second set of at least one pin.

3. The rail removal apparatus of claim 2, wherein the first set of at least one pin comprises two pins and the second set of at least one pin comprises six pins.

4. The rail removal apparatus of claim 2, wherein when the upper holder is pushed downwards, the first set of at least one pin is pushed downwards towards the first frame.

5. The rail removal apparatus of claim 2, wherein when the lower holder is pushed downwards, the second set of at least one pin is pushed downwards towards the first frame.

6. The rail removal apparatus of claim 1, wherein a second frame is secured to the first frame.

7. The rail removal apparatus of claim 6, wherein the first frame is a ring frame and the second frame is a lead frame holding a work piece.

8. The rail removal apparatus of claim 1, wherein the panel comprises at least one channel through which the rail removal assembly can move over the panel.

9. The rail removal apparatus of claim 1, wherein the first frame contains at least one blocking nut.

10. A method of removing rails from a second frame holding a work piece secured to a first frame, the method comprising:
placing the first frame on a side rail removal apparatus with removal pins;
pushing a rail removal assembly over the first frame, the pins removing rails from the second frame, until the rails of the second frame are removed in a horizontal orientation;
returning the rail removal assembly to a home position and then rotating the first frame to a different position;
pushing the rail removal assembly over the first frame, the pins removing rails from the second frame, until the rails of the second frame are removed in a vertical orientation.

11. The rail removal method of claim 10, wherein the first frame is a ring frame comprising the second frame holding the work piece; the work piece is a semiconductor package; and the first frame is a lead frame.

12. The rail removal method of claim 10, wherein when the rails of the second frame are removed in a horizontal direction, a blocking nut prevents the pins from removal of the rails of the second frame in a vertical position.

13. The rail removal method of claim 10, wherein when the rails of the second frame are removed in a vertical direction, a blocking nut prevents the pins from removal of the rails of the second frame in a horizontal position.
